(19) United States
(12) Patent Application Publication
(10) Pub. No.: US 2012/0144165 A1
(43) Pub. Date: Jun. 7, 2012

(54) SIDEBAND PAYLOADS IN PSEUDO NO-OPERATION INSTRUCTIONS

(75) Inventor: Anthony J. Bybell, Chapel Hill, NC (US)

(73) Assignee: INTERNATIONAL BUSINESS MACHINES CORPORATION, Armonk, NY (US)

(21) Appl. No.: 12/961,784

(22) Filed: Dec. 7, 2010

(51) Int. Cl. G06F 9/30

(52) U.S. Cl. 712/208; 712/E09.016

(57) ABSTRACT

A pseudo no-op instruction in an instruction stream is detected, and the pseudo no-op instruction is decoded as being an opcode, wherein a parameter of the pseudo no-op instruction uniquely identifies the opcode. The method makes use of a pseudo no-op instruction and provides the pseudo no-op instruction with additional semantics outside of the instruction stream execution. New or enhanced functionality can be implemented in application software in a fashion that fully preserves backward compatibility to software and processors that do not support the new or enhanced functionality. If these functionalities are not supported, then the legacy software or processor will merely see and execute the pseudo no-op instruction, which will effectively do nothing at all.

### BACKGROUND

1. Field of the Invention

The present invention relates to processor instruction sets.

2. Background of the Related Art

An instruction set, or instruction set architecture (ISA), is the part of computer architecture related to programming. The instruction set includes operation codes, or opcodes, that specify an operation to be performed by the processor. Over time, an instruction set may be expanded to include new opcodes that provide additional functionality over the previously existing opcodes. However, to prevent making existing software obsolete, it is desirable to maintain backward compatibility of the instruction set. Accordingly, computer architects may add new opcodes to an existing instruction set, rather than create an entirely new instruction set, in order to implement the new functionality while maintaining compatibility with existing software applications.

Furthermore, new software may be written that makes use of the very latest in functionality of the instruction set that is operable only with the latest processor designs. It is desirable, however, if this new software can be installed on almost any computer regardless of its processor and instruction set. Accordingly, it is valuable to be able to write software that is backwardly compatible with older processors and their instruction sets, while benefiting from enhanced performance when operated on newer processors and their expanded instruction sets.

### BRIEF SUMMARY

One embodiment of the present invention provides a method comprising detecting a pseudo no-op instruction in an instruction stream, and decoding the pseudo no-op instruction as being an opcode, wherein a parameter of the pseudo no-op instruction uniquely identifies the opcode.

Another embodiment of the invention provides an apparatus comprising a decoder to detect a pseudo no-op instruction and decode the pseudo no-op instruction as being an opcode, wherein a parameter of the pseudo no-op instruction uniquely identifies the opcode, and an execution unit to execute an operation indicated by the opcode.

Yet another embodiment of the invention provides a computer program product including computer usable program code embodied on a computer usable storage medium. The computer program product comprises computer usable program code for detecting a pseudo no-op instruction in an instruction stream, and computer usable program code for decoding the pseudo no-op instruction as being an opcode, wherein a parameter of the pseudo no-op instruction uniquely identifies the opcode.

BRIEF DESCRIPTION OF THE SEVERAL VIEWS OF THE DRAWINGS

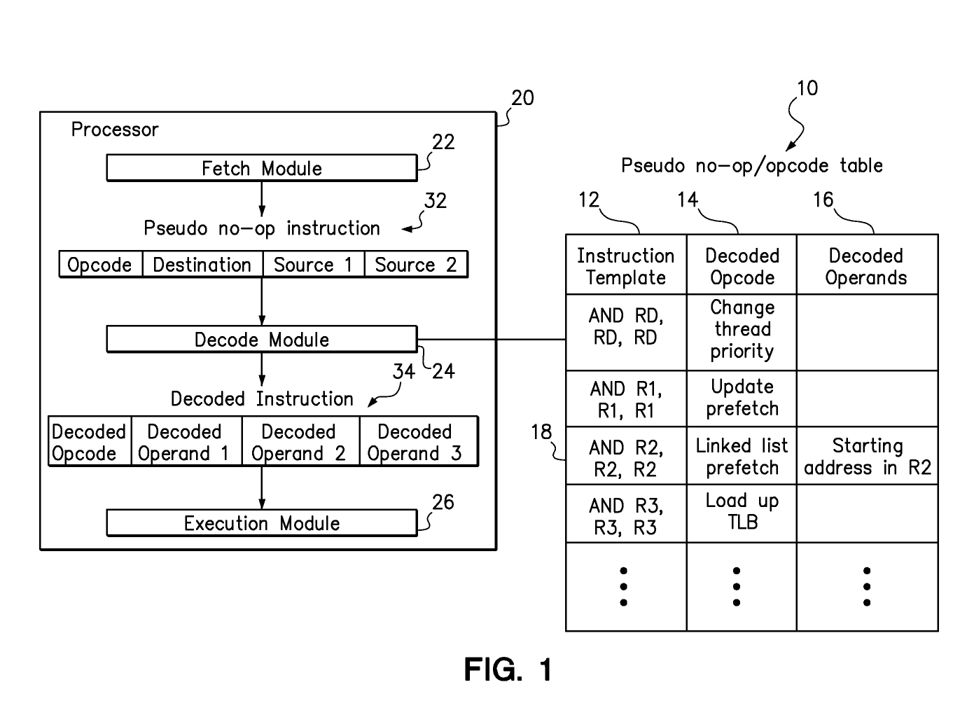

FIG. 1 is a diagram illustrating the decoding of a pseudo no-op instruction as an opcode in accordance with an embodiment of the invention.

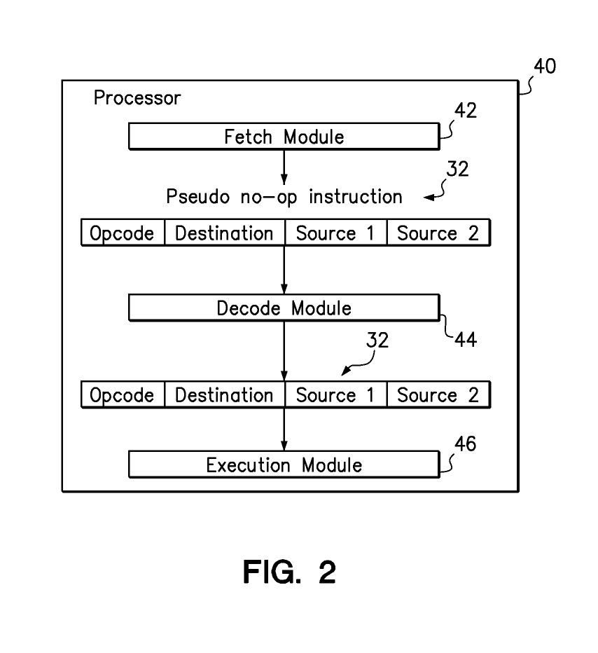

FIG. 2 is a diagram illustrating that the same pseudo no-op instruction of FIG. 1 is still backward compatible with a processor that does not support decoding of a pseudo no-op instruction as an opcode.

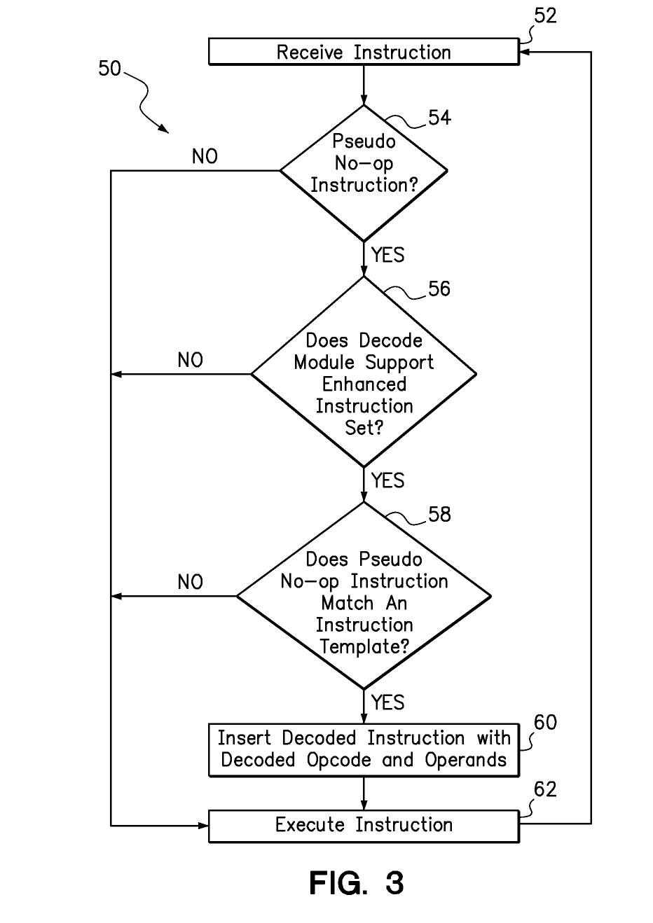

FIG. 3 is a flowchart of a method according to an embodiment of the invention.

### DETAILED DESCRIPTION

One embodiment of the present invention provides a method comprising detecting a pseudo no-op instruction in an instruction stream, and decoding the pseudo no-op instruction as being an opcode, wherein a parameter of the pseudo no-op instruction uniquely identifies the opcode. A no-op instruction (alternatively, “nop” or “noop”), short for “no operation” or “no operation performed”, is an explicit command in various instruction set architectures (ISAs) that effectively does nothing at all. However, the present invention involves the use of pseudo no-op instructions, which are various combinations of an opcode (short for “operation code”), operands, and immediate values that collectively are effective to do nothing at all. Since instruction set architectures provide explicit no-op instructions, there is no particular reason to ever intentionally use a pseudo no-op instruction, such that a pseudo no-op is typically considered to be a mistake or error. Embodiments of the present invention make use of a pseudo no-op instruction and provide the pseudo no-op instruction with additional semantics outside of the instruction stream execution. Accordingly, embodiments of the present invention may be used to provide new or enhanced functionality to application software in a fashion that fully preserves backward compatibility to software and processors that do not support the new or enhanced functionality. For example, the new functionality might include initiating prefetching for a linked list, setting values in some problem state configuration registers, or providing hints that would improve application performance. Preferably, the decoded opcode is of a type that provides a performance enhancement without a substantively different result. If these functionalities are not supported, then the legacy software or processor will merely see and execute the pseudo no-op instruction, which will effectively do nothing at all.

According to various embodiments of the invention, the decoded opcode may be identified by one or more parameter of the pseudo no-op instruction. In a first option, the parameter identifying the opcode is an operand, immediate value, or both. For example, a pseudo no-op instruction may be provided as “AND Rx, Rx, Rx”, where the instructions include fields <opcode, destination address, source address 1, source address 2>. According to this instruction, the logical operation AND is performed using source address 1 and source address 2, and the resulting value is stored in the destination address. Since the source address 1 is Rx and the source address 2 is also Rx, the logical operation AND is performed on two instances of the value in Rx. Therefore, the value of Rx ANDed with the value of Rx is also the value of Rx. Since the value of Rx is then stored in the destination address, Rx, the result of the pseudo no-op instruction is to effectively do nothing. However, embodiments of the method may recognize the instruction template “AND Rx, Rx, Rx” as indicating that an enhanced opcode should be executed by the execution module.

In one embodiment, an instruction template for a pseudo no-op instruction may uniquely identify a decoded opcode. Accordingly, a plurality of instruction templates may be available, such that each instruction template uniquely identifies a decoded opcode.

In another embodiment, an instruction template for a pseudo no-op instruction may be associated with a plurality of decoded opcodes, where a particular decoded opcode is identified by a parameter of the pseudo no-op instruction. In one option, one or more of the three operands (i.e., Rx, Rx, Rx) may be used to identify the particular decoded opcode to be executed. In a second option, one or more immediate values may be used to identify the particular decoded opcode. In a third option, the content of a register identified in the pseudo no-op instruction may be used to identify the particular decoded opcode. In a fourth option, a specified register may be used to identify the decoded opcode, wherein the opcode is executed using the value in the register as an operand. Combinations of the foregoing parameters may be used to identify a decoded opcode and, optionally, to provide one or more operands. It should be recognized that the various ways to identify a decoded opcode in a pseudo no-op instruction enable the method to be used to execute any of a large number of decoded opcodes.

In order to detect a pseudo no-op instruction in an instruction stream, one embodiment uses a set of instruction templates that represent known pseudo no-op instructions for a particular instruction set. For example, a decode module of a processor may include or have access to pseudo no-op instruction templates, such as the following (for Power ISA assembly language):

a) AND Rx, Rx, Rx

b) OR Rx, Rx, Rx

c) ADDI Rx, Rx, 0

d) ADDIS Rx, Rx, 0

e) MULLI Rx, Rx, 1

f) ISEL Rx, Rx, Rx, IMM (where Rx <>0 and IMM is any legal immediate value)

g) ORI Rx, Rx, 0

h) ORIS Rx, Rx, 0

i) XORI Rx, Rx, 0

j) XORIS Rx, Rx, 0

k) rotates which leave the destination equal to the source

<vector instruction logical ops, etc.>

It should be recognized that the concepts in this disclosure are applicable to any instruction set which supports an instruction constructed such that execution of the instruction produces no change of architectural state. For example, on x86, the pseudo no-op instruction might include “andps xmm0, xmm0”, “orps xmm0, xmm0”, and the like.

It should be recognized that a pseudo no-op instruction may, in accordance with various embodiments, provide more than one operand or payload. For example, an pseudo no-op instruction such as “ISEL Ra, Ra, Rb” includes both Ra and Rb. So long as neither Ra nor Rb is destroyed by execution of the instruction both Ra and Rb can be used as sideband payloads.

In a still further embodiment, the pseudo no-op instruction may be executed, and any flag that is altered as a result of executing the pseudo no-op instruction may be reset. In this manner, the state of the processor will be truly unaffected by the pseudo no-op instruction. Alternatively, a read of a source register or a write to a destination register may be ignored since these actions will presumably effectively result in no change.

Another embodiment of the invention provides an apparatus comprising a decoder to detect a pseudo no-op instruction and decode the pseudo no-op instruction as being an opcode, wherein a parameter of the pseudo no-op instruction uniquely identifies the opcode, and an execution unit to execute an operation indicated by the opcode. The decoder may operate to implement any of the foregoing method embodiments.

Yet another embodiment of the invention provides a computer program product including computer usable program code embodied on a computer usable storage medium. The computer program product comprises computer usable program code for detecting a pseudo no-op instruction in an instruction stream, and computer usable program code for decoding the pseudo no-op instruction as being an opcode, wherein a parameter of the pseudo no-op instruction uniquely identifies the opcode. It should be recognized that the computer program product may include computer usable program code for implementing any of the foregoing method embodiments.

FIG. 1 is a diagram illustrating the decoding of a pseudo no-op instruction as an opcode instruction in accordance with an embodiment of the invention. An instruction set has been analyzed to determine various pseudo no-op instructions that may be used to invoke an opcode instruction. A corresponding set of instruction templates are identified and stored in a table 10. Each row of the table associates one of the pseudo no-op instruction templates (in the first column 12) with a decoded opcode (in the second column 14). Optionally, the table may further include directions (in the third column 16) for identifying and obtaining decoded operands or immediate values that should be used during execution of the decoded opcode. Although the number of operands and/or immediates may vary based upon the opcode, the directions (in the third column 16) may identify one or more of the operands or immediates. The table 10 is setup and made accessible to the decode module 24 before an instruction stream is provided to the processor 20.

In operation, an instruction stream is provided to a fetch module 22 of the processor 20. The instruction stream is then directed from the fetch module 22 to a decode module 24 one instruction at a time. Here, an instruction 32 is being transferred to the decode module 24, where the instruction 32 is compared with instruction templates (in the first column 12) of the table 10. If the instruction 32 is determined to match one of the pseudo no-op instruction templates in the table, then the decode module 24 will replace that pseudo no-op instruction 32 with a new instruction containing the associated decoded opcode (in the second column 14) and, if available, decoded operands or immediates (in the third column 16). It should be recognized that a decoded opcode or decoded operand or immediate is “associated”, in the context of a table, by being in the same row or record.

The decoded instruction 34 is then inserted into the instruction stream as it is passed to the execution module 26. Embodiments may substitute the decoded instruction 34 for the pseudo no-op instruction 32, or execute both the decoded instruction 34 and the pseudo no-op instruction 32 in either order. However, it should be noted that the pseudo no-op instruction 32 has resulted in the execution of a decoded instruction 34. As discussed above, the decoded instruction will preferably provide enhanced performance of the processor in handling the instruction stream.

In a hypothetical implementation, after detecting that the pseudo no-op instruction 32 matches the instruction template “AND R2, R2, R2” in row 18 of table 10, the source register R2 is read. According to the table 10, there are four instruction templates (in the first column 12), where the register number (i.e., the “2” in R2) is used to identify the decoded opcode (in the second column 14). In this hypothetical implementation, the following register numbers contain the following opcodes:

R0: change the thread priority to the value present in R0

R1: update the prefetch configuration register with the value in R1

R2: initiate linked list prefetch starting at the effective address value present in R2

R3: load up TLB (via hardware table walk) with the mapping for the page pointed to by the address present in R3 <etc>

The register targeted in the instruction “AND R2, R2, R2” is register two (“R2”). Accordingly, “AND R2, R2, R2” indicates that the data cache should take the value in R2 and use it to start a linked list prefetch traversal. As this function is a speculative hint, no exceptions should be generated. (i.e., any “bad” translation causes the prefetching to stop).

Furthermore, since “AND R2, R2, R2” is a pseudo no-op instruction, the write to the destination register can be blocked or ignored as it serves no useful purpose. The result of the foregoing steps is a method for encoding a payload in a pseudo no-operation instruction. By encoding in this manner, processors which support the sideband payload decoding can take advantage of enhanced performance without sacrificing backward compatibility with processors which do not.

Code using this feature is hardware “backwards” compatible since the commands will not affect program flow/execution in hardware that does not provide the additional hardware decode function. Compiler libraries should be made aware of the intended use of these pseudo no-op instructions to avoid removal of the pseudo no-op instruction or other alteration that would prevent the pseudo no-op instruction from being decoded properly by the decode module 24.

FIG. 2 is a diagram illustrating that the same pseudo no-op instruction 32 of FIG. 1 is still backward compatible with a processor 40 that does not support decoding of a pseudo no-op instruction as an opcode. In the absence of the pseudo no-op/opcode table 10 of FIG. 1, or related decode module logic, the decode module 44 merely passes the pseudo no-op instruction 32 to the execution module 46 without alteration. Such instruction 32 will be executed and have no effect on the processor state.

FIG. 3 is a flowchart of a method 50 according to an embodiment of the invention. In step 52, a decode module receives an instruction from an instruction stream. Step 54 determines whether the instruction is a pseudo no-op instruction. If the instruction is not a pseudo no-op instruction, then the process executes the instruction in step 62. However, if the instruction is in fact a pseudo no-op instruction, then the process proceeds to step 56, whether it is determined whether the decode module supports an enhanced instruction set (i.e., decoded opcodes). If the decode module does not support an enhanced instruction set, then the process advances to step 62 such that the pseudo no-op instruction is executed with no effect. However, if the decode module does in fact support an enhanced instruction set, then step 58 determines whether the pseudo no-op instruction matched an instruction template in a pseudo no-op/opcode table. If there is no match, then the instruction is executed in step 62 with no effect. On the other hand, if the pseudo no-op instruction does in fact match an instruction template in a pseudo no-op/opcode table, then step 60 inserts a decoded instruction with the decoded opcode and decoded operands that are associated with the matching instruction template. Following step 60, the decode instruction is executed in step 62. Whenever an instruction has been executed in step 62, the process returns to step 52 to receive another instruction until the instruction stream has been processed.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
detecting a pseudo no-op instruction in an instruction stream; and
decoding the pseudo no-op instruction as being an opcode, wherein a parameter of the pseudo no-op instruction uniquely identifies the opcode.

2. The method of claim 1, wherein the parameter identifying the opcode is an operand, immediate value, or both.

3. The method of claim 1, wherein the parameter identifying the opcode is a specified register.

4. The method of claim 3, further comprising:
executing the opcode using the value in the register as an operand.

5. The method of claim 1, wherein the parameter identifying the opcode is a different opcode than in the pseudo no-op-instruction.

6. The method of claim 1, wherein the parameter identifying the opcode is the content of a register identified in the pseudo no-op-instruction.

7. The method of claim 1, wherein a processor that supports decoding the pseudo no-op instruction as being an opcode can execute the opcode while maintaining backward compatibility with a processor that does not support decoding the pseudo no-op instruction as being an opcode.

8. The method of claim 1, wherein the opcode provides a performance enhancement without a substantively different result.

9. The method of claim 1, further comprising:
reading a source register according to the pseudo no-op instruction.

10. The method of claim 1, further comprising:
ignoring a write to a destination register that is indicated by the pseudo no-op instruction.

11. The method of claim 1, further comprising:
executing the pseudo no-op instruction;
resetting any flag that is altered as a result of executing the pseudo no-op instruction.

12. An apparatus comprising:
a decoder to detect a pseudo no-op instruction and decode the pseudo no-op instruction as being an opcode, wherein a parameter of the pseudo no-op instruction uniquely identifies the opcode; and
an execution unit to execute an operation indicated by the opcode.

13. The apparatus of claim 12, wherein the parameter identifying the opcode is an operand, immediate value, or both.

14. The apparatus of claim 12, wherein the parameter identifying the opcode is a specified register.

15. The apparatus of claim 14, wherein the opcode is executed using a value in the specified register as an operand.

16. The apparatus of claim 12, wherein the parameter identifying the opcode is a different opcode in the pseudo no-op-instruction.

17. The apparatus of claim 12, wherein the parameter identifying the opcode is the content of a register identified in the pseudo no-op-instruction.

18. A computer program product including computer usable program code embodied on a computer usable storage medium, the computer program product comprising:
computer usable program code for detecting a pseudo no-op instruction in an instruction stream; and
computer usable program code for decoding the pseudo no-op instruction as being an opcode, wherein a parameter of the pseudo no-op instruction uniquely identifies the opcode.

19. The computer program product of claim 18, wherein the parameter identifying the opcode is an operand, immediate value, or both.

20. The computer program product of claim 18, wherein the parameter identifying the opcode is a specified register.

21. The computer program product of claim 20, further comprising:
computer usable program code for executing the opcode using the value in the register as an operand.

22. The computer program product of claim 18, wherein the parameter identifying the opcode is a different opcode in the pseudo no-op-instruction.

23. The computer program product of claim 18, wherein the parameter identifying the opcode is the content of a register identified in the pseudo no-op-instruction.
